(19) United States
(12) Patent Application Publication
(10) Pub. No.: US 2007/0075288 A1
(43) Pub. Date: Apr. 5, 2007

(54) Gate valve

(75) Inventors: Stephen R Matte, Norfolk, MA (US); Steven P. Young, Billerica, MA (US); Joseph P. Johnson, Concord, MA (US)

Correspondence Address: Varian Inc.;Legal Department, 3120 Hansen Way D-102, Palo Alto, CA, 94304, US

(73) Assignee: VARIAN, INC., PALO ALTO, CA (US)

(21) Appl. No.: 10/555,221

(22) PCT Filed: Apr. 30, 2004
(86) PCT No.: PCT/US04/13574

§ 371 Date: Nov. 20, 2006

Related U.S. Application Data
(60) Provisional application No. 60/467,806, filed on May 2, 2003.

(51) Int. Cl. F16K 25/00

(52) U.S. Cl. 251/167

(57) ABSTRACT

The gate valve includes a valve housing (12) having a fluid conduit (14) and defining a valve seat (16) and a support surface (18), a seal plate (20), a counter plate (22) having cushion (72) vulcanized to a surface facing the support surface (18), and an actuator (34) for moving the seal plate and the counter plate between respective open and closed positions. The cushion is configured to prevent metal-to-metal contact between the counter plate and the support surface of the valve housing.

### CROSS REFERENCE TO RELATED APPLICATION

This application claims the benefit of provisional application Ser. No. 60/467,806, filed May 2, 2003, which is hereby incorporated by reference in its entirety.

### FIELD OF THE INVENTION

This invention relates to valve structures and, more particularly, to gate valve structures and methods which are configured for low particulate generation.

### BACKGROUND OF THE INVENTION

Conventional gate valve structures include a valve housing having a fluid conduit and a valve seat, a seal plate that is movable between an open position and a closed position in the fluid conduit, and an actuator mechanism for moving the seal plate between the open and closed positions. The seal plate engages the valve seat and seals the fluid conduit in the closed position. The seal plate may be moved from the closed position to a retracted position and then moved linearly to the open position.

Gate valves are used in a wide variety of applications. Different applications may involve liquids, gases, and vacuum. Many applications require a long operating life, with frequent cycling between the open and closed positions, and low particulate generation. An example of such an application is in equipment for processing of semiconductor wafers. As semiconductor device geometries decrease in size and circuit densities increase, semiconductor wafers are increasingly sensitive to particulate contamination. Components within the vacuum envelope of the processing chamber, such as gate valves, are potential sources of particulate contamination. Furthermore, the failure of a gate valve may require all or part of a semiconductor fabrication line to shut down, thereby adversely affecting throughput. Accordingly, long operating life and low particulate generation are important gate valve characteristics.

A gate valve having a linearly movable seal plate is disclosed in U.S. Pat. No. 4,052,036 issued Oct. 4, 1977 to Schertler. The seal plate and a counter plate are biased toward each other by leaf springs. The actuator carries a series of rollers which engage recesses in the seal plate and the counter plate. When the seal plate and the counter plate reach a stop position, the actuator continues to move, forcing the rollers out of the recesses and moving the seal plate and the counter plate toward closed positions. The seal plate engages a valve seat, and the counter plate engages a support surface. The counter plate provides support for the seal plate in the closed position and prevents the seal plate from being forced away from the valve seat by a pressure differential across the valve.

Gate valves used in processing equipment for the semiconductor industry utilize an elastomer seal on the inlet or seal plate side of the valve and either no elastomer or an O-ring on the outlet side. When the valve is closed, the seal plate contacts the valve seat through the elastomer seal on the seal plate. The counter plate contacts the support surface by metal-to-metal contact. The semiconductor industry demands low particulate generating equipment. Metal-to-metal contact generates particulates which may damage sensitive semiconductor devices being processed. Such particulates are not acceptable to the semiconductor industry.

Accordingly, there is a need for improved gate valve structures and methods.

### SUMMARY OF THE INVENTION

According to a first aspect of the invention, a valve is provided. The valve comprises a valve housing having a fluid conduit and defining a valve seat and a support surface, a seal plate, a counter plate having a cushion on a surface facing the support surface, and an actuator for moving the seal plate and the counter plate between respective open and closed positions.

The cushion may be in the form of a circular ring cushion that is vulcanized to the counter plate. The cushion may be configured to prevent direct contact between the counter plate and the support surface. In some embodiments, the cushion comprises an elastomer that is vulcanized to the counter plate without use of a groove.

According to a second aspect of the invention, a method is provided for operating a gate valve. In the gate valve, a seal plate engages a valve seat and a counter plate engages a support surface in a closed position. The method comprises preventing direct contact between the counter plate and the support surface.

### BRIEF DESCRIPTION OF THE DRAWINGS

For a better understanding of the present invention, reference is made to the accompanying drawings, which are incorporated herein by reference and in which:

FIG. 1 is a partial, cross-sectional side view of an embodiment of a gate valve in accordance with the invention, shown in a closed position;

FIG. 2 is a partial, cross-sectional side view of the valve of FIG. 1, shown in a first retracted position; and

FIG. 3 is a partial, cross-sectional side view of the valve of FIG. 1, shown in a second retracted position.

### DETAILED DESCRIPTION OF THE INVENTION

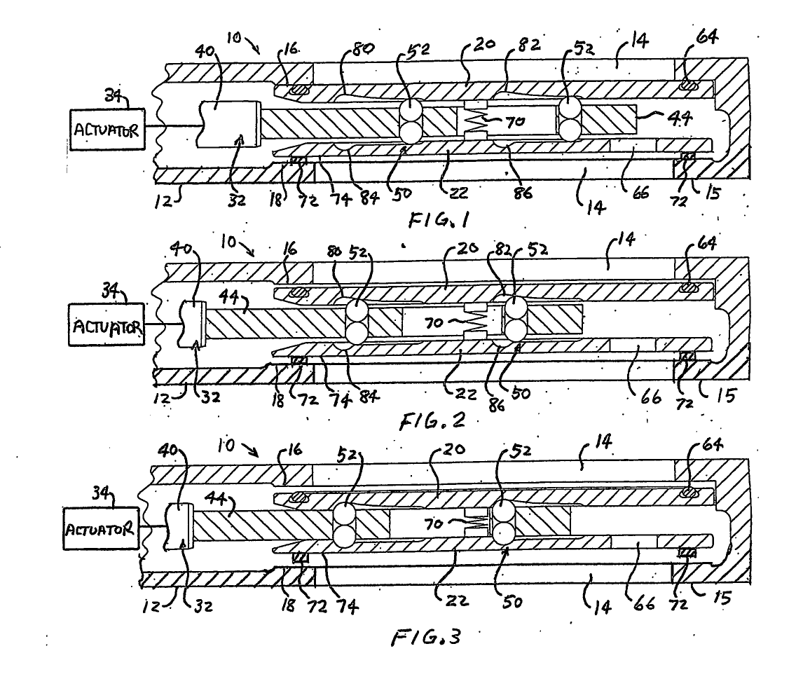

An embodiment of a gate valve in accordance with the present invention is shown in FIGS. 1-3. Like elements in FIGS. 1-3 have the same reference numerals.

A gate valve 10 includes a valve housing 12 having a fluid conduit 14 for passage of a gas or a liquid and a flange 15 for attachment of the valve to other system components. The gas pressure may be low in the case of vacuum applications of the gate valve. Valve housing 12 defines a valve seat 16 for engagement with a seal plate, as described below. Valve housing 12 also defines a support surface 18 for engagement with a counter plate, as further described below. Fluid conduit 14 may be generally cylindrical, square, rectangular or any other suitable shape. Valve seat 16 and support surface 18 may each have the form of a surface that surrounds fluid conduit 14.

Gate valve 10 further includes a seal plate 20, a counter plate 22 and an actuator assembly 32, and may include a valve actuator 34, such as an air cylinder. In an alternate configuration, actuator 34 is replaced with a handle or other suitable device for manual operation of the gate valve. Actuator assembly 32 includes a shaft 40 connected at one end to valve actuator 34. The opposite end of shaft 40 is connected to an actuator element 44.

Seal plate 20 and counter plate 22 are positioned on opposite sides of actuator element 44. An elastomer ring 64 is mounted in a groove in seal plate 20 for producing a vacuum-tight seal between valve seat 16 and seal plate 20 when the valve is closed. A cushion 72 is bonded to a surface 74 of counter plate 22, as described below. Surface 74 faces support surface 18 of valve housing 12. Counter plate 22 may include a vent hole 66 for rapid pressure equalization.

A coupling mechanism 50 is disposed between actuator element 44, seal plate 20 and counter plate 22. Coupling mechanism 50 controls movement of seal plate 20 and counter plate 22 between closed and retracted positions, as described below. As described below, coupling mechanism 50 includes rollers 52, grooves in seal plate 20 and counter plate 22, and one or more springs connected between seal plate 20 and counter plate 22. Rollers 52, which may be balls, are movably mounted in openings in actuator element 44.

Coupling mechanism 50 includes at least one spring 70, which is attached at one end to seal plate 20 and is attached at the other end to counter plate 22. Spring 70 biases seal plate 20 and counter plate 22 toward each other. When the valve is closed, spring 70 is deformed, as shown in FIG. 1, thereby producing a restoring force that tends to pull seal plate 20 and counter plate 22 toward each other. It will be understood that leaf springs, Belleville springs, coil springs or any other suitable springs may be utilized within the scope of the present invention.

Seal plate 20 is provided with a groove 80 and a groove 82. Counter plate 22 is provided with a groove 84 and a groove 86. Grooves 80, 82, 84 and 86 are positioned and shaped to engage the respective rollers 52.

Under control of actuator assembly 32 and valve actuator 34, seal plate 20 and counter plate 22 are movable between a closed position shown in FIG. 1, retracted positions shown in FIGS. 2 and 3 and an open position (not shown). In the open position, seal plate 20 and counter plate 22 are moved away from fluid conduit 14 into an upper portion of valve housing 12 to permit passage of a liquid or a gas. In the closed position, seal plate 20 is in sealed engagement with valve seat 16, thereby blocking passage of a liquid or a gas through fluid conduit 14.

In operation, shaft 40 moves seal plate 20, counter plate 22 and actuator element 44 from the closed position shown in FIG. 1 to the first retracted position shown in FIG. 2 and then to the second retracted position shown in FIG. 3. In the closed position shown in FIG. 1, rollers 52 engage shallow portions of grooves 80, 82, 84 and 86. This causes seal plate 20 to be in sealed engagement with valve seat 16 and causes cushion 72 on counter plate 22 to be in engagement with support surface 18. Counter plate 22 provides support for seal plate 20 in the closed position and prevents a pressure differential across the valve 10 from forcing seal plate 20 away from engagement with valve seat 16.

Cushion 72 is configured to prevent metal-to-metal contact between counter plate 22 and support surface 18 of valve housing 12. By preventing such metal-to-metal contact during opening and closing of the valve, particulate contamination is substantially reduced in comparison with prior art gate valves. Cushion 72 is not required to perform a sealing function, as is evident from the use of vent hole 66 in counter plate 22.

Cushion 72 is positioned on counter plate 22 so as to contact support surface 18 of valve housing 12 when the valve is closed, as shown in FIG. 1. Typically, cushion 72 is located at or near the outer periphery of counter plate 22. Cushion 72 may have the form of a closed loop strip that generally matches the shape of fluid conduit 14 but has larger dimensions so as to contact support surface 18. Thus, cushion 72 may be circular, square, rectangular or any other suitable shape. The dimensions of cushion 72 depend on the dimensions of fluid conduit 14.

Cushion 72 may be bonded to surface 74 of counter plate 22. In some embodiments, cushion 72 is an elastomer material and is vulcanized to surface 74 of counter plate 22. The vulcanization process is a known process which involves heating and molding of an elastomer material. The elastomer material may be molded in place so as to adhere to surface 74 of counter plate 22. Because cushion 72 is bonded to surface 74, a retaining groove is not required. Various elastomer materials may be utilized. For semiconductor processing applications, a fluoroelastomer sold under the trademark Viton may be utilized. This elastomer material is approved by the semiconductor industry for use in semiconductor processing equipment. Other materials, such as a perfluoroelastomer sold under the trademark Kalrez, a more chemically inert material, are also acceptable. The configuration and durometer of cushion 72 and the known design load result in a maximum compression of 3-5%. The cross-section is selected to limit compression and to prevent metal-to-metal contact. The cushion 72 may have a rectangular cross section and may have a width in a range of about 0.050 to 0.300 inch and a thickness in a range of about 0.005 to 0.300 inch.

By avoiding use of an O-ring in an O-ring groove, several potential sources of particulate contamination are eliminated. In many cases, an O-ring positioned in an O-ring groove can be compressed by a sufficient amount to permit metal-to-metal contact, thereby increasing the risk of particulate generation. Furthermore, an O-ring can roll in its groove and create particulates. In addition, gas can be trapped in an O-ring groove, in which case the O-ring groove acts as a virtual leak.

Having thus described various illustrative non-limiting embodiments, and aspects thereof modifications and alterations will be apparent to those who have skill in the art. Such modifications and alterations are intended to be included in this disclosure, which is for the purpose of illustration and explanation, and not intended to define the limits of the invention. The scope of the invention should be determined from proper construction of the appended claims and equivalents thereof.

What is claimed is:

1. A valve comprising:
a valve housing having a fluid conduit and defining a valve seat and a support surface;
a seal plate;
a counter plate having a cushion on a surface facing the support surface; and
an actuator for moving said seal plate and said counter plate between respective open and closed positions.

2. A valve as defined in claim 1, wherein the cushion is vulcanized to the counter plate.

3. A valve as defined in claim 1, wherein the cushion has a shape that is configured to generally match a shape of the fluid conduit.

4. A valve as defined in claim 1, wherein the cushion is configured as a circular ring cushion.

5. A valve as defined in claim 4, wherein the circular ring cushion is vulcanized to the counter plate without use of a groove.

6. A valve as defined in claim 1, wherein the cushion is an elastomer material.

7. A valve as defined in claim 1, wherein the cushion is a fluoroelastomer.

8. A valve as defined in claim 1, wherein the cushion is a perfluoro-elastomer.

9. A valve as defined in claim 1, wherein the counter plate and the support surface are metal.

10. A valve as defined in claim 1, wherein the cushion is configured to prevent direct contact between the counter plate and the support surface.

11. A valve as defined in claim 1, wherein the cushion is in engagement with the support surface in the closed position of said valve and the cushion is retracted from the support surface in the open position of said valve.

12. A valve comprising:
a valve housing having a fluid conduit and defining a valve seat and a support surface;
a seal plate;
a counter plate;
an actuator for moving said seal plate and said counter plate between respective open and closed positions; and
means for preventing direct contact between the counter plate and the support surface.

13. A valve as defined in claim 12, wherein said means for preventing direct contact comprises a cushion vulcanized to a surface of the counter plate facing the support surface.

14. A valve as defined in claim 12, wherein said means for preventing direct contact comprises a circular ring cushion vulcanized to a surface of the counter plate facing the support surface.

15. A method for operating a gate valve, wherein a seal plate engages a valve seat and a counter plate engages a support surface in a closed position, comprising:
preventing direct contact between the counter plate and the support surface.

16. A method as defined in claim 15, wherein preventing direct contact comprises providing a cushion vulcanized to a surface of the counter plate facing the support surface.

17. A method as defined in claim 15, wherein preventing direct contact comprises providing an elastomer cushion vulcanized to a surface of the counter plate facing the support surface.
